(19) United States
(12) Patent Application Publication
(10) Pub. No.: US 2005/0253580 A1
(43) Pub. Date: Nov. 17, 2005

(54) Method of pseudopolar acquisition and reconstruction for dynamic MRI

(76) Inventors: Feng Huang, Gainesville, FL (US); Hu Cheng, Gainesville, FL (US); G. Randy Duensing, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/128,731

(22) Filed: May 13, 2005

Related U.S. Application Data
(60) Provisional application No. 60/571,299, filed on May 13, 2004.

(51) Int. Cl. G01V 3/00

(52) U.S. Cl. 324/307; 324/309

(57) ABSTRACT

The subject invention pertains to a method for magnetic resonance imaging (MRI) involving the acquisition of pseudo-polar K-space data and creation of an MRI image from the pseudo-polar K-space data. In an embodiment, the subject method can incorporate a scan scheme for acquiring pseudo-polar K-space data and corresponding reconstruction technique. Advantageously, the subject method can result in reduced motion artifact in dynamic MRI with short acquisition time and short reconstruction time. In a specific embodiment, the subject method can incorporate a reconstruction method utilizing Fractional FFT in MRI. The subject method can allow the acquisition of pseudo-polar K-space data. In a specific embodiment, the acquisition of the pseudo-polar is accomplished by one shot. Other acquisition techniques can also be utilized in accordance with the subject invention. In an embodiment, the pseudo-polar K-space data can lie at the origin of K-space and on N linearly growing concentric squares, with N≦2, where the distance between adjacent concentric squares is the same as the distance from the origin to the innermost square. The K-space data on the N concentric squares are equally spaced from adjacent data points on the same square, including data points at the corners of each square.

### CROSS-REFERENCE TO RELATED APPLICATIONS

The present application claims priority to U.S. Provisional Application Ser. No. 60/571,299, filed May 13, 2004, which is hereby incorporated by reference herein in its entirety, including any figures, tables, or drawings.

### BACKGROUND OF INVENTION

Motion correction is important in magnetic resonance imaging (MRI) technology. There are many well known sources of artifact in MRI. For example, intra-view motion artifacts arise from motion dependent phase shifts resulting from motion between RF excitation and end of the acquisition window (i.e., within echo time), along non-zero moment gradient waveforms used for spatial encoding or slice selection. Inter-view inconsistencies occur, particularly in abdominal imaging, when the tissue position changes from one view to the next and lead to motion-dependent modulations of the NMR image data, predominantly along the phase-encoding direction(s) following N-dimensional Fourier transform (N-DFT) reconstruction.

Various techniques have been developed to correct motion artifacts by modifying the data acquisition and/or by post-processing the collected data, including navigator echoes (R. L. Ehman and J. P. Felmlee, “Adaptive technique for high definition MR imaging of moving structures,” Radiology, vol. 173, pp. 255-263., 1989; X. Hu and S. G. Kim, “Reduction of signal fluctuation in functional MRI using navigator echoes,” Magn Reson Med, vol. 31, pp. 495-503, 1994; T. S. Sachs, C. H. Meyer, B. S. Hu, J. Kohli, and D. G. Nishimura, “Real-time motion detection in spiral MRI using navigators,” Magn Reson Med, vol. 32, pp. 639-645, 1994; and Y. Wang, R. C. Grimm, J. P. Felmlee, S. J. Reiderer, and R. L. Ehman, “Algorithms for extracting motion information from navigator echoes,” Magn Reson Med, vol. 36, pp. 117-12³, 1996) and adaptive methods without navigators (M. Stehling, R. Turner, and P. Mansfield, “Echo-planar imaging: magnetic resonance imaging in a fraction of a second.,” Science, vol. 254, pp. 43-50, 1991). Navigator-echo-based adaptive motion correction is a promising technique for retrospectively removing the effects of global motion that uses additional echoes inserted in the pulse sequence to directly measure inter- and intra-view motion in specific directions. However, navigator-echo techniques require extra sampling and thus longer acquisition time. Fast imaging techniques (e.g., Fast Low Angle Shot (FLASH)), Fast Imaging with Steady-State Processing (FISP), Echo-Planar Imaging (EPI), and Spirals) have also been used to considerably reduce motion artifacts by acquiring the data with sufficient speed to ensure that little motion occurs during the acquisition (C. H. Meyer, B. Hu, D. G. Nishimura, and A. Macovski, “Fast spiral coronary artery imaging,” Magn Reson Med, pp. 202-213, 1992; A. Haase, J. Frahm, D. Matthaei, W. Hanicke, and K. Merboldt, “FLASH imaging: rapid NMR imaging using low flip-angle pulses.,” J Magn Reson, vol. 67, pp. 258-266, 1986; J. Frahm, W. Hanicke, and K. D. Merboldt, “Transverse coherence in rapid FLASH imaging,” J Magn Reson, vol. 72, pp. 307-314, 1987; A. Oppelt, R. Graumann, H. Barfuss, H. Fischer, W. Hartl, and W. Shajor, “FISP—a new fast MRI sequence,” Electromedica, vol. 54, 1986). Despite reductions in the overall level of artifacting, rapid imaging techniques have sometimes suffered from problems of reduced signal-to-noise ratio (SNR), increased sensitivity to off-resonance artifacts, and less robust contrast when compared to longer scan duration spin-echo sequences.

Radial K-space (FIG. 1A) acquisitions have been proposed as an alternative to rectilinear K-space coverage schemes with two-dimension Fourier Transform (2DFT) reconstruction because of a number of advantages, such as 1) inherent over-sampling of the low spatial frequencies (analogous to signal averaging), 2) off-resonance artifacts manifesting as streaks radiating perpendicular to the direction of the moving structures motion, rather than discrete ghosts, and 3) radial K-space may provide improved spatial resolution throughout the field of view in a given scan time as compared to rectilinear sampling. This improved resolution is accompanied by artifacts that appear to be tolerable (C. J. Bergin, J. M. Pauly, and A. Macovski, “Lung parenchyma: projection reconstruction MR imaging,” Radiology, vol. 179, pp. 777-781, 1991). This advantage in spatial resolution can be taken to reduce the total scan time, as used in angularly undersampled projection-reconstruction (PR). While the use of radial acquisitions and PR may lead to significant motion artifact reduction, people still struggle with long construction time and image quality (residual streaks and object blurring often remain).

Recently, the pseudo-polar Fast Fourier Transform (FFT) was introduced. The basic idea is to use pseudo-polar (FIG. 1B) instead of polar trajectory and apply the fractional FFT to reconstruct it. Pseudo-polar has properties similar to polar, such as over-sampling of the low spatial frequencies, so that pseudo-polar acquisition should preserve many, if not all, of the advantages of radial imaging. However, the computation complexity of Fourier Transform for pseudo-polar trajectory is much simpler than polar trajectory.

Other references have also discussed motion artifacts in fMRI by using radial K-space acquisition (G. H. Glover and A. T. Lee, “Motion artifacts in fMRI: comparison of 2DFT with PR and spiral scan methods,” Magn Reson Med, vol. 33, pp. 624-635, 1995).

Other publications which may provide background with respect to the subject technology include: J. P. Felmlee, R. L. Ehman, S. J. Riederer, and H. W. Korin, “Adaptive motion compensation in MR imaging without the use of navigator echoes,” Radiology, vol. 179, pp. 139-142, 1991; D. C. Peters, F. R. Korosec, T. M. Grist, W. F. Block, J. E. Holden, K. K. Vigen, and C. A. Mistretta, “Undersampled projection reconstruction applied to MR angiography,” Magn Reson Med, vol. 43, pp. 91-101, 2000; A. Averbuch, R. Coifman, D. Donoho, M. Israeli, and J. Walden, “The Pseudopolar FFT and its application,” 2003; and D. H. Bailey and P. N. Swarztrauber, “The Fractional Fourier Transform and Applications,” SIAM Review, vol. 33, pp. 389-404, 1991.

### BRIEF SUMMARY OF THE INVENTION

The subject invention pertains to a method for magnetic resonance imaging (MRI) involving the acquisition of pseudo-polar K-space data and creation of an MRI image from the pseudo-polar K-space data. In an embodiment, the subject method can incorporate a scan scheme for acquiring pseudo-polar K-space data and corresponding reconstruction technique. Advantageously, the subject method can result in reduced motion artifact in dynamic MRI with short acquisition time and short reconstruction time. In a specific embodiment, the subject method can incorporate a reconstruction method utilizing Fractional FFT in MRI. The subject method can allow the acquisition of pseudo-polar K-space data. In a specific embodiment, the acquisition of the pseudo-polar is accomplished by one shot. Other acquisition techniques can also be utilized in accordance with the subject invention. In an embodiment, the pseudo-polar K-space data can lie at the origin of K-space and on N linearly growing concentric squares, with N≦2, where the distance between adjacent concentric squares is the same as the distance from the origin to the innermost square. The K-space data on the N concentric squares are equally spaced from adjacent data points on the same square, including data points at the corners of each square.

Where polar (radial) acquisition typically involves acquisition of K-space data through which rays can be drawn having equal angular spacing between adjacent rays, pseudo-polar K-space data acquired in accordance with the subject invention can have equal spacing between K-space data that lie on the same square in, for example, the Kₓ and K_{y} directions. FIG. 1A shows an example of polar K-space data where the grid data points lie at the intersection of concentric circles and the equal angular spaced rays passing through the center point, with each concentric circle being the same distance from the previous circle as the initial circle is from the center point. FIG. 1B shows pseudo-polar K-space data in accordance with an embodiment of the subject invention, where the data points lie at the intersection of linearly growing concentric squares and rays passing through the center, or origin in K-space, with each concentric square being the same distance from the previous square as the initial square is from the center point, or origin in K-space. The embodiment shown in FIG. 1 B is for N=8, where N is the number of concentric squares. In addition, in accordance with the subject invention, there are at least three K-space data points on each side of each square used to show the pseudo-polar K-space grid on which the K-space data points lie, including the two data points at the corners at the end of each side of the square. In other words, there is at least one data point on each side which is not at a corner of the square. In a preferred embodiment, there are N+1 such data points on each side, including the two corners on each side, where N is the number of concentric squares. Please note that the corner data lies on the two adjacent sides of the square in the description provided. However, each corner data point need only be acquired once. The K-space date points are equidistance from adjacent data points lying on the same square. In an embodiment, the data is acquired on only two adjacent sides of the outer square and only the corner at the intersection of the two adjacent sides and one corner at the end of one of the two adjacent sides. In this way, only 4N²−2N+1 K-space data points are acquired. FIG. 1C shows this case for N=8. Note, referring to FIG. 1C, data points are not acquired on the top side of the outer square or the right side of the outer square except for the lower right corner. Alternatively, a portion, or all, of the remaining data points on the outer square can be acquired. In an embodiment, the portion, or all, of the remaining data points on the outer square are acquired and only the data from the two adjacent sides, as described above and illustrated in FIG. 1 C, is utilized in the creation of the image. The number of data points on the outer square that need not be acquired in such an embodiment is 2N, which is typically a small number compared with the number of data points acquired.

In an embodiment, N is even. In another specific embodiment N is greater than or equal to 256. In another embodiment, N is odd. N is preferably larger than or equal to 128. Preferably, N is a power of 2.

Three dimensional K-space data can also be acquired and utilized in accordance with the subject invention. FIG. 8A shows the three dimensional structure of “pseudo-polar” K-space data, which can be acquired and utilized for imaging in accordance with the subject invention. The data lies on a grid of concentric cubes and each data point is equally spaced from adjacent data points lying on the same cube in the Kₓ, K_{y}, or K_{z} direction, where each cube is the same distance from the previous cube as the first cube is from the center point. FIG. 8A shows the outer cube and four rays, with each ray passing through the origin and two corners of each concentric cube, where the other concentric cubes within the outer cube are not shown for clarity purposes. The cube of data can be viewed as the combination of data in the geometric forms shown in FIGS. 8B, 8C, and 8D, which when put together form a cube. Note, the data on the three geometric forms shown in FIGS. 8B, 8C, and 8D corresponding to overlapping cube sides and corners of the cubes need only be acquired once, in much the same way that the corners of the concentric squares in FIG. 1B need only be acquired once (e.g., see FIGS. 9A and 9B for example of scan scheme that only measures corners once).

In an embodiment, data points on the outer cube are only acquired on a portion of the outer cube, analogous to the outer square shown in FIG. 1C, such that only 6N³−3N²+1 data points are acquired and used to create the image. Again, in alternative embodiments, the data on a portion, or all, of the remaining portion of the outer cube can be acquired and, then can, optionally, not be used during the creation of the image. If all of the data points on the N cubes and the origin are acquired, then 6N³+1 data points are acquired. Again, the 3N² points that are not acquired in the embodiment discussed is typically small. In an embodiment involving N concentric cubes and the K-space origin, N is even. In another embodiment, N is odd. Preferably, N is greater than or equal to 128. Preferably, N is a power of 2.

The subject invention can overcome the error of adjoint Fractional FFT by increasing the field of view (FOV) and then only using part of the reconstructed image as the region of interest (ROI). Advantageously, the subject method can be quite fast.

In alternative embodiments, the subject method can utilize alternative techniques for reconstruction of the image. An example of such an alternative technique involves taking the result of adjoint Fractional FFT as an initial image and then applying the Conjugate Gradient method to iteratively solve for the true image. This technique is very accurate but may take more time. Another example involves interpolating based on the onion peel method. This technique takes more time and is more accurate.

The subject method can enjoy many, if not all of the advantages of polar (radial) imaging. The subject method can also enjoy a shorter reconstruction time. The complexity of reconstruction for pseudo-polar is n² log n (same as FFT), while the complexity of reconstruction for radial K-space is n³. In a specific experiment, the reconstruction for pseudo-polar K-space required 0.687 seconds for a 256×256 image with 4.5% error and the reconstruction required 7 seconds for a 256×256 image with 0.01% error

The subject technique can be applied to various MRI procedures, such as cardiac MRI and functional MRI. Advantageously, this technique can generate better images (less motion artifacts) with less acquisition and reconstruction time.

### BRIEF DESCRIPTION OF DRAWINGS

FIG. 1A shows a polar (radial) grid.

FIG. 1B shows a pseudo-polar grid.

FIG. 1C shows a pseudo-polar grid indicating data points acquired with respect to a specific embodiment of the subject invention, where the open-square data points were acquired during a scan of a first, or horizontal, “bow-tie” portion of the grid and the filled-square data points were acquired during a scan of a second, or vertical, “bow-tie” portion of the grid, and where data points for two corners and interior portions of two adjacent sides of the outermost square of the grid need not be acquired.

FIG. 2A shows a schematic drawing of a K-space trajectory that can be used in accordance with a specific embodiment of the subject invention.

FIGS. 2B-2E show schematic drawings of gradient settings of a specific pulse sequence that can be used in accordance with the subject invention.

FIG. 3 shows a sum-of-squares of 4 channel simulated data, which is used as the reference for a reconstructed image, in accordance with an embodiment of the subject invention.

FIG. 4 shows the results for an experiment with under-sampled pseudo-polar K-space, showing a reconstructed image for ½ under sampled (2×256×256 points in pseudo-polar K-space) and an associated difference with original sum of squares and a reconstructed image for ¼ under-sampled (256×256 points in pseudo-polar K-space) and an associated difference with an original sum of squares.

FIG. 5 shows reconstructed images resulting from a reconstruction with prior information (RPID) with under-sampled pseudo-polar K-space, along with an associated difference with original sum of squares, for ½ under sampled, ¼ under sampled, and ⅛ under sampled.

FIGS. 6A, 6B, 6C and 6D show: an original T1-weighted image (64×64); field distortion; a reconstructed EPI image; and a reconstructed image using pseudo-polar imaging, respectively, in accordance with an embodiment of the subject invention.

FIGS. 7A and 7B show: an activation map from original data; and an activation map from simulated data, respectively, in accordance with an embodiment of the subject invention.

FIG. 8A-8D show: the outer cube of a 3-dimensional K-space grid made up of N linearly growing concentric cubes and four rays, each ray passing through the origin and two corners of each concentric cube, in accordance with a specific embodiment of the subject invention, and three geometric forms that can form the cube shown in FIG. 8A when combined.

FIG. 9A and 9B show: “bow-tie” grids that represent portions of the N concentric squares and the rays passing through the origin where data points lie at the origin and the intersection of the portions of the concentric squares, where the combination of the horizontal bow-tie grid of FIG. 9A and the vertical bow-tie grid of FIG. 9B form a K-space grid as shown in FIG. 1C.

FIG. 10 schematically illustrates an operator H_{n,k} for pseudo-polar to Cartesian resampling within a single row, in accordance with a specific embodiment of the subject invention.

FIG. 11 illustrates a technique for recovering Cartesian points from pseudo-polar points, starting from the outside, where the Cartesian samples are known, and proceeding one ‘layer’ at a time by sequential application of H_{n,k} operators.

### DETAILED DISCLOSURE

The subject invention pertains to a method for magnetic resonance imaging (MRI) involving the acquisition of pseudo-polar K-space data and creation of an MRI image from the pseudo-polar K-space data. In an embodiment, the subject method can incorporate a scan scheme for acquiring pseudo-polar K-space data and corresponding reconstruction technique. Advantageously, the subject method can result in reduced motion artifact in dynamic MRI with short acquisition time and short reconstruction time. In a specific embodiment, the subject method can incorporate a reconstruction method utilizing Fractional FFT in MRI.

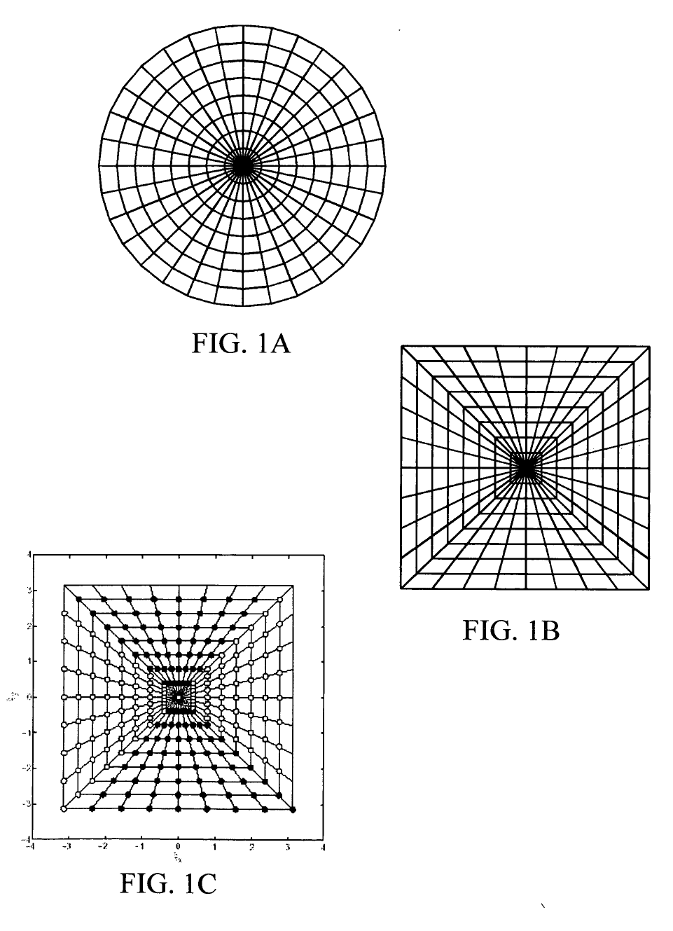

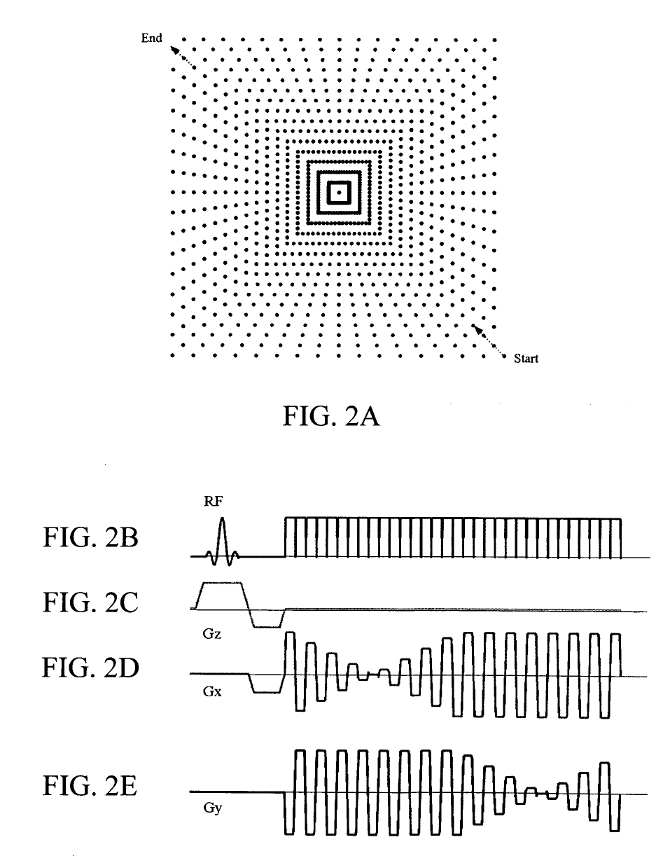

With respect to the acquisition technique for a specific embodiment of the subject invention, for each ray in Z zone, or the vertical “bow-tie” region, of the pseudo-polar system, the amplitude of y gradient is kept constant, and the amplitude of x gradient is set to

$${G}_{x} = \frac{2 m}{N} {G}_{y} , m ∈ [ - N / 2 , N / 2 ]$$

Where the Gₓ is a time varying gradient field in the x-direction, G_{y} is a time varying gradient field in the y-direction, N is the number of pixels in the image in the x-direction, and m is the indice of rays. For adjacent lines, y gradients have opposite signs. The same relation of gradient amplitudes can be implemented with x and y exchanged for each other in the above equation. We then obtain the trajectory as shown in FIG. 1B. The N zone, or horizontal “bow-tie” region, can be acquired in a similar way. The subject process is similar to EPI and can be realized in much the same way. FIGS. 2A, 2B, 2C and 2D, and 2E show schematic drawings of gradient settings of the pulse sequence corresponding to the K-space trajectory of FIG. 2A, in accordance with the acquisition portion of a specific embodiment of the subject invention.

The subject invention can incorporate a variety of reconstruction methods. Examples of reconstruction methods which can be used in accordance with the subject invention include adjoint Fractional FFT method, conjugate gradient method, and onion peel method. A particularly fast method is the adjoint Fractional FFT method. However, the adjoint Fractional FFT is not the exact inverse of Fractional FFT, hence significant errors may result in the reconstructed image. To overcome this problem, three techniques may be applied. One technique is to increase the field of view (FOV) and then only use part of the reconstructed image as the region of interest (ROI). This technique does not increase the acquisition time because the over-sampling is actually in the frequency-encoding direction. The resultant error is between 3% to 5% but very smooth across the image. The second technique is to take the results of the adjoint Fractional FFT processing as an initial image, then apply the conjugate gradient method to iteratively solve for the final image. The third technique is to apply the onion peel method, based on interpolation. All of these techniques can increase the acquisition time and/or the reconstruction time by, for example, a factor of 2 or more. The first technique can generate a reasonable result in a short time. The second technique can generate a very accurate result but reconstruction may take a long time. The third technique is likely the best all around.

TABLE 1
shows the comparison of the 1st and 2nd method

| | Full acquired | | | |
|---|---|---|---|---|
| | points for a | Reconstruction time | | Relative |
| | n × n image | for a 256 × 256 image | | error |
| adjoint Fractional | 4 × n × n | 0.687 | seconds | 4.5% |
| FFT | | (with C code) | | |
| Conjugate Gradient | 4 × n × n | 7 | seconds | 0.01% |

(with C code)

Experiments have been conducted using simulated cardiac image data having 4 channels in the data and a field of view (FOV) of 256×256. FIG. 3 shows the sum-of-squares, which is used as the reference for the reconstructed image. In this data, we assume the noise correlation and accurate sensitivity maps are given. The random noise which follows the noise correlation is added, and the L2 norm of the noise is 5% of the L2 norm of signal. In all of these experiments, the 1st reconstruction technique is applied. To simulate the increased FOV, the original image is zero padded. Because the original image size is 256×256, the number of points in pseudo-polar K-space is 4×256×256.

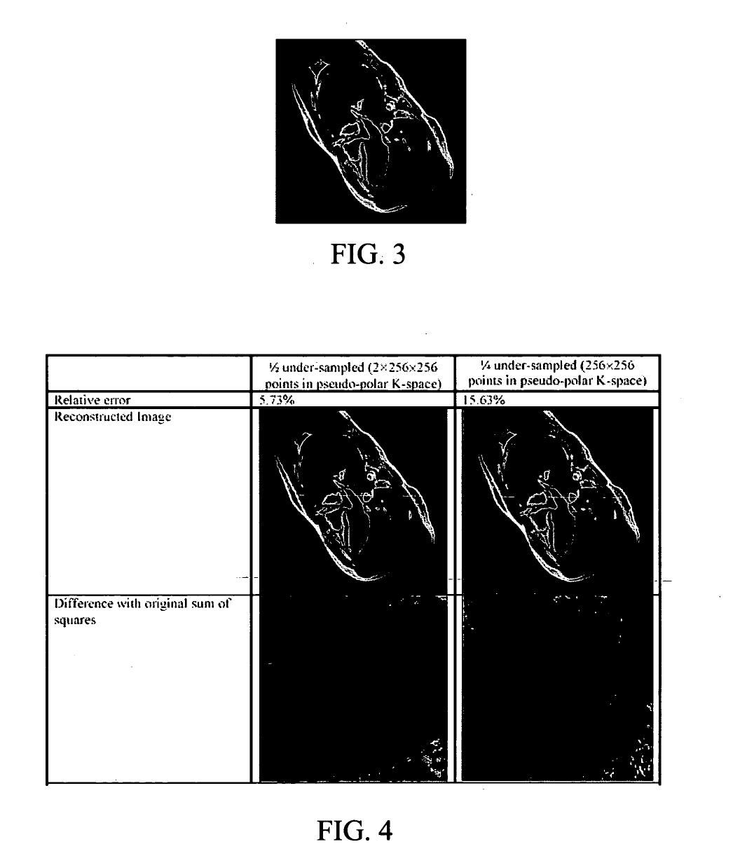

A direct reconstruction experiment was performed to show the reconstruction result with under-sampled pseudopolar K-space, with zero-padding to missing data. FIG. 4 shows the reconstructed images and the difference between reconstructed image and the original image.

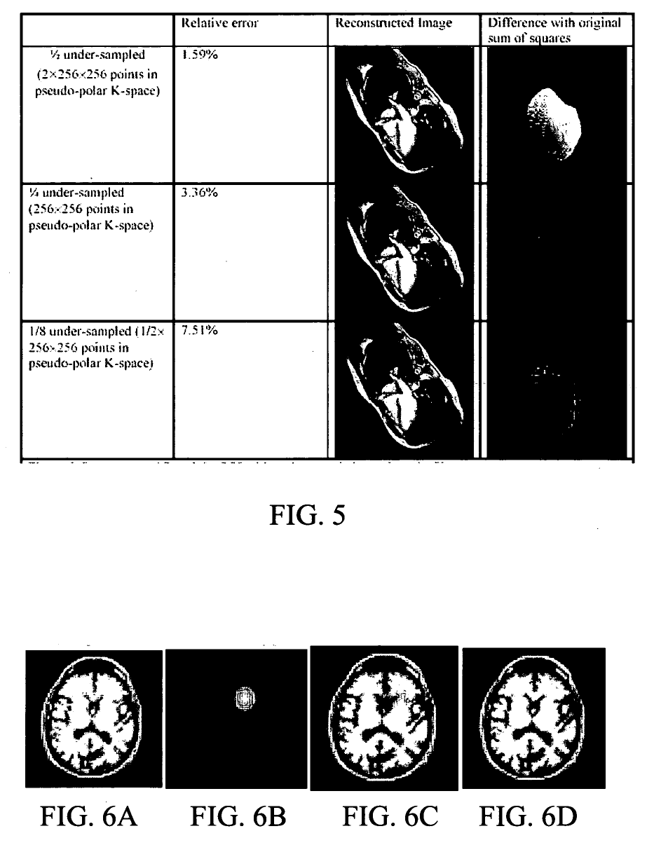

For dynamic images, reconstruction with prior information (RPID) can be directly applied in accordance with the subject invention. (F. Huang, J. Akao, A. Rubin, R. Duensing, “Parallel Imaging with Prior Information for Dynamic MRI”, Proc. IEEE ISBI, pp. 217-220, 2004. A description of a method for reconstruction with prior information (RPID) which can be applied in accordance with the subject invention is provided in U.S. provisional patent application Ser. No. 60/519,320, filed Nov. 12, 2003, which is herein incorporated by reference in its entirety. The use of the Cartesian FFT in RPID can simply be replaced by the pseudo-polar and inverse pseudo-polar transforms. Another experiment was performed to show the application of RPID on pseudo-polar K-space. FIG. 5 shows the results of this experiment.

The subject method can be applied to various MRI applications, including, for example, cardiac MRI and functional MRI. Advantageously, the subject method is not sensitive to motion and can have very short TE (echo time). In addition, off resonance artifacts are likely to only appear as blurring and radial streaks, rather than appearing as displacement, as occurs in, for example, traditional EPI. In this way, the correction and registration is much easier.

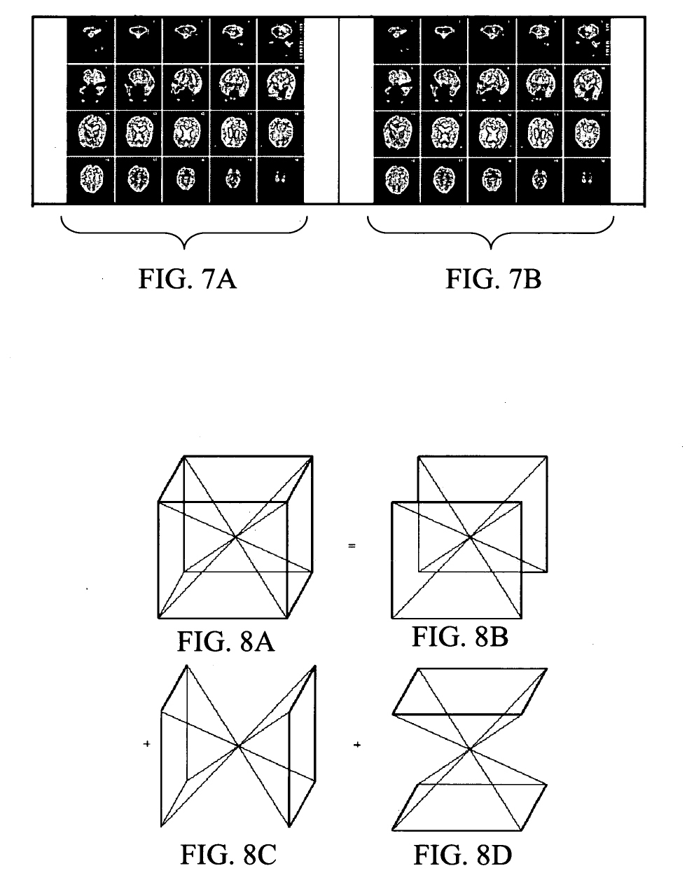

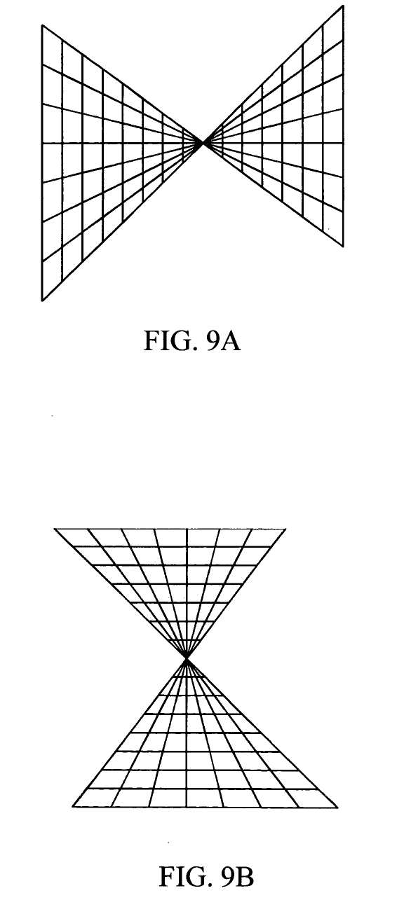

Although the fast reconstruction in accordance with the subject method may lead to less accuracy, the fast reconstruction does not affect the statistics in fMRI because the error is consistent for both ‘on’ and ‘off’ states. We simulated the pseudo-polar acquisition by applying the pseudo-polar FFT and its adjoint inverse to a fMRI data set, and then processed both in the same way with fMRI software, BrainVoyager™, to detect the activations. FIGS. 7A and 7B show the results of this simulation, which show that the activation map remains essentially the same.

The subject invention pertains to a method for reconstruction of MRI images from pseudo-polar K-space data. In an embodiment, the subject reconstruction method can utilize the fractional fast Fourier transform. The implementation of the reconstruction can be varied depending on the requirements for accuracy and time consumption. In an embodiment, the adjoint fast fractional Fourier transform can be utilized for reconstruction of the MRI images. In another embodiment, the onion peel method can utilize interpolation for reconstruction of the MRI images. In yet another embodiment, the conjugate gradient solution can be utilized for reconstruction of the MRI images.

The fast fractional Fourier transform was introduced by David H. Bailey and Paul N. Swarztrauber (D. H. Bailey and P. N. Swarztrauber, “The Fractional Fourier Transform and Applications,” SIAM Review, vol. 33, pp. 389-404, 1991). The fast fractional Fourier transform (FFRFT) has computation complexity proportional to the fast Fourier transform (FFT). Whereas the discrete Fourier transform (DFT) is based on integral roots of unity e^{-2πi/n}, the fractional Fourier transform (FRFT) is based on fractional roots of unity e^{-2πi/α}, where α is arbitrary.

The Fractional Fourier Transform can be defined as

$${G}_{k} ( x , α ) = {\sum }_{j = 0}^{m - 1} {x}_{j} {ⅇ}^{- 2 π ijk α} \qquad ( 1 )$$

Notice that the ordinary DFT is defined as

$$\begin{matrix}{F}_{k} ( x ) = {\sum }_{j = 0}^{m - 1} {x}_{j} {ⅇ}^{- 2 π ijk / m} \\ = {G}_{k} ( x , 1 / m ) 0 \leq K < m\end{matrix} \qquad ( 2 )$$

Similarly the inverse of DFT is

$$\begin{matrix}{F}_{k} ( x ) = \frac{1}{m} {\sum }_{j = 0}^{m - 1} {x}_{j} {ⅇ}^{2 π ijk / m} \\ = \frac{1}{m} {G}_{k} ( x , - 1 / m ) 0 \leq K < m\end{matrix} \qquad ( 3 )$$

In case α is a rational number, the FRFT can be reduced to be a DFT and can thus be evaluated using conventional FFTs. Suppose that α=r/n, where the integers r and n are relatively prime and where n≦m. Let p be the integer such that 0≦p≦n and pr≡1 (mod n). Extend the input sequence x to length n by padding with zeros. Then

$$\begin{matrix}{G}_{k} ( x , α ) = {\sum }_{j = 0}^{m - 1} {x}_{j} {ⅇ}^{- 2 π ijkr / n} \\ = {\sum }_{j = 0}^{n - 1} {x}_{pj} {ⅇ}^{- 2 π i ( pj ) kr / n} \\ = {\sum }_{j = 0}^{n - 1} {x}_{pj} {ⅇ}^{- 2 π ijk / n} \\ = {F}_{k} ( y ) , 0 \leq k < n\end{matrix} \qquad ( 4 )$$

where y is the n-long sequence defined by yⱼ=xₚⱼ and where subscripts are interpreted modulo n. Thus, FRFT can be computed by performing an n-point FFT on the sequence y. And then take the first m values of this DFT as the result. The cost of this operation is 5n log₂ⁿ. Since we only use the m values, it is possible to reduce the computation complexity.

The Fast Fractional Fourier Transform algorithm is based on a technique known in the signal processing field as the “chirp z-transform”. By noting that 2jk=j²+k²−(k−j)². The expression for the FRFT then becomes

$$\begin{matrix}{G}_{k} ( x , α ) = {\sum }_{j = 0}^{m - 1} {x}_{j} {ⅇ}^{- π i ( {j}^{2} + {k}^{2} - {( k - j )}^{2} ) α} \\ = {ⅇ}^{- π {ik}^{2} α} {\sum }_{j = 0}^{m - 1} {x}_{j} {ⅇ}^{- π {ij}^{2} α} {ⅇ}^{π {i ( k - j )}^{2} α} \\ = {ⅇ}^{- π {ik}^{2} α} {\sum }_{j = 0}^{m - 1} {y}_{j} {z}_{k - j}\end{matrix} \qquad ( 5 )$$

where the m-long sequences y and z are defined by
yⱼ=xⱼe^{-πij}^{²}^{α}
zₖ=e^{πij}^{²}^{α}

Notice summation (5) is in the form of a discrete convolution, it suggests evaluation using the well-known DFT based procedure. However, the usual DFT method evaluates circular convolutions. This condition is not satisfied here. Therefore, we can convert this summation into a form that is a circular convolution. Select an integer p≦m−1, and extend the sequences y and z to the length 2p as follows:
yⱼ=0, m≦j<2p
zⱼ=0, m≦j<2p−m
zⱼ=e^{πi(j-2p)}^{²}, 2p−m≦j<2p

Now it is a circular convolution and

$$\begin{matrix}{G}_{k} ( x , α ) = {ⅇ}^{- π {ik}^{2} α} {\sum }_{j = 0}^{2 p - 1} {y}_{j} {z}_{k - j} , 0 \leq k < m \\ = {ⅇ}^{- π {ik}^{2} α} {F}_{k}^{- 1} ( w ) , 0 \leq k < m\end{matrix} \qquad ( 6 )$$

where w is the 2p -long sequence defined by wₖ=Fₖ(y)Fₖ(z). It should be emphasized that this equality only holds for 0≦k<m. The computation complexity is 20m log₂^{m}.

In an embodiment, the pseudo-polar FFT method utilized in accordance with the subject invention for the PFFT can use the pseudo-polar FFT. The pseudo-polar FFT is an FFT where the evaluation frequencies lie in an over-sampled set of non-angularly equispaced points. The pseudo-polar grid can be separated into two groups—the Basically Vertical (BV) and the Basically Horizontal (BH) subsets. FIG. 1C shows a pseudo-polar grid that has been separated into BV and BH subsets for N=8. The BV group (filled dots in FIG. 1C) is defined by

$$BV = \{ \begin{matrix}{ξ}_{y} = \frac{π l}{N} for - N \leq l < N \\ {ξ}_{x} = \frac{2 π m l}{{N}^{2}} for - \frac{N}{2} \leq m < \frac{N}{2}\end{matrix} \} \qquad ( 7 )$$

and a similar definition describes the BH group. Whereas the polar grid is built as the points on the intersection between linearly growing concentric circles and angularly equispaced rays, the pseudo-polar grid is built as the points on the intersection between linearly growing concentric squares and linearly growing sloped rays, where the spacing between adjacent data points on the concentric squares, located at the intersection of the concentric squares and the sloped rays, are equal.

In an embodiment, the computation for the Fourier transform from Cartesian grid to BV grids is as following:
1. Let I be the input image of size (nₒ,mₒ). I is zero-padded to a size of (n,n)=(2^{k} ,2^{k}), k∈Z , where k is chosen such that 2^{k}≧2˜Max(n₀,m₀)
2. A 1-D FFT is applied on the Y direction I_{\overline{x}}=FFT_{X}(I) and the result is cyclically shifted. (The shift operation is similar to the “fftshift” command in Matlab™)
3. Apply the fast fractional Fourier transform Gₖ(x,aₖ) to the k^{th} row of I_{\overline{x}},1≦k≦n. BV^{k}=Gₖ(I_{\overline{x}}ⁱ,αₖ), where BV^{k} is the k^{th} row of BV and the compression ratio αₖ is the defined as

$${α}_{k} = \{ \begin{matrix}\frac{n - 2 k}{n} & k < \frac{n}{2} \\ 0 & k = \frac{n}{2} \\ - \frac{n - 2 k}{n} & k > \frac{n}{2}\end{matrix} \qquad ( 8 )$$

The lower half a BV is flipped left-right.

For the construction ofBH, we transpose the input image I and apply the above algorithm.

Adjoint Pseudo-Polar FFT is the rapid approximation of the inverse of Pseudo-Polar FFT. Since BV^{k}=Gₖ(FFT_{X}(I),αₖ), i.e. BV=G_{α}∘FFT(I). Hence I=F₋₁∘G_{-α}(BV) where F₋₁ is the inverse of FFT. However, G_{-α} is not the accurate inverse of G_{α}. Therefore, we can define
Î=F₋₁∘G_{-α}E(BV)+F₋₁∘G_{-α}∘E(BH), (9)
where E is the extension operator which extends an array indexed by −n/2≦l<n/2 to be an array indexed −n≦l<n, using zero-padding. In this way, interpolation can be used instead of extrapolation by zero padding outside points.

There are several methods for reconstruction of pseudo-polar K-space data in accordance with the subject invention, including, for example, adjoint pseudo-polar FFT method, conjugate gradient (CG) method, and onion peel method. The adjoint pseudo-polar FFT method is the fastest of these three examples and was introduced above. However, the adjoint Fractional FFT is not the exact inverse of Fractional FFT, which can produce error in the reconstructed image. Nevertheless, if the field of view (FOV) is increased and then only part of the reconstructed image is used as the region of interest (ROI), the error can be very small and smoothly distributed.

The conjugate gradient method can be used in the reconstruction of pseudo-polar K-space data in accordance with the subject invention. The pseudo-polar K-space data, K, can be obtained by applying the pseudo-polar transform P to the true image I.
PI=K. (10)

Reconstruction can be accomplished by solving for I from K. The image can be reconstructed to a high accuracy by applying the adjoint transform \tilde{P} to the pseudo-polar K-space data although the adjoint transform is not the exact inverse of the pseudo-polar transform.
\tilde{P}K=Ĩ≈Ĩ. (11)

Since an approximate solution already exists, the exact solution can be sought by iterations. The conjugate gradient method is an iterative method for solving sparse hermitian linear systems. It was proved that the product of the two operators \tilde{P}P is hermitian. So for this hermitian operator \tilde{P}P, I can be solved for from the linear equation
(\tilde{P}P)I=Ĩ (12)
iteratively by conjugate gradient method starting from the approximate solution Ĩ.

Pseudo-polar-to-Cartesian conversion by onion peeling can be accomplished in accordance with the subject invention. Suppose we are working in dimension one, have a trigonometric polynomial T of degree n and period 2n, and are equipped with samples of T at two different sampling rates. For α=2k/n, we have density-normalized samples
\sqrt{α}T(αl), −n/2≦l≦n/2
as well as
T(l), k≦|l|≦n
Suppose these data are packaged into a vector W and consider the operator H_{n,k}, which, given such data, recovers the unique trigonometric polynomial T having such samples and then delivers the values
T(l), 0≦|l|≦k

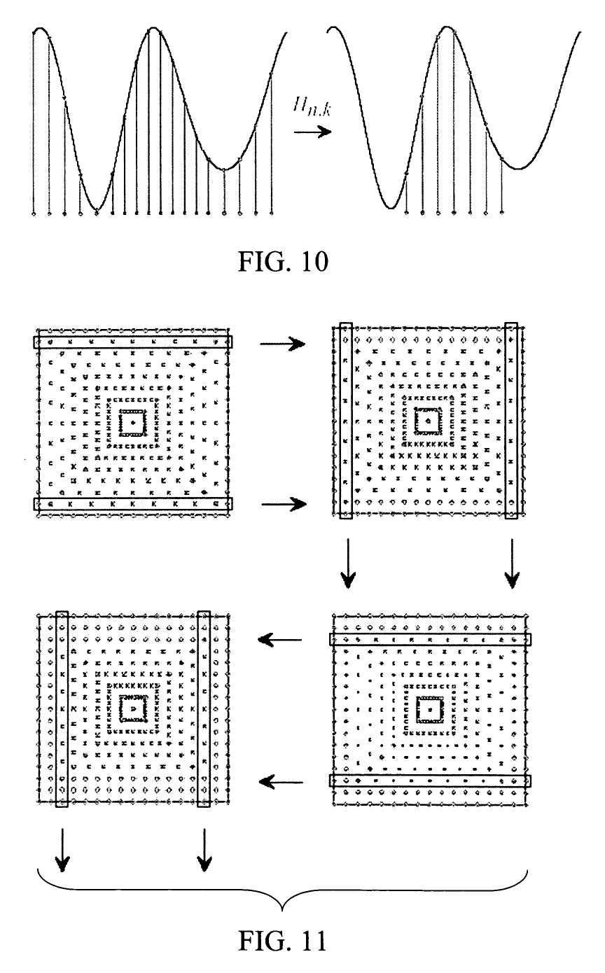

This is a linear operator, taking as argument vectors of 2n−2k values and yielding as output vectors containing 2k−1 values. The problem is illustrated in FIG. 10.

The operator describes a process of resampling from data that are oversampled at two different rates to data that are uniformly sampled at twice the Nyquist rate.

Given the 1-dimensional operators H_{n,k}, a full 2-dimensional conversion can be performed from knowledge of pseudo-polar to knowledge of Cartesian samples. To begin, if the pseudo-polar samples are known, then the Cartesian samples are also known at the edges of the domain [π,π]₂, along the main diagonal and skew diagonal, and along the axes. Now consider the problem of recovering all the Cartesian samples on the square associated with |k|=n/2−1. To get the Cartesian samples in the top row s=1, k=n/2−1, the operator H_{n,n1} can be applied to a vector consisting of the n+1 pseudo-polar samples in that row, together with the two Cartesian samples at the extremes of the array (which were known to begin with). Analogous steps are accomplished in the bottom row s=1, k=−n/2+1 and in the rightmost column s=2, k=n/2−1 and the leftmost column s=2, k=−m/2+1. At this point, all the Cartesian samples have been received in the outermost two concentric squares. Continuing in this way, the Cartesian samples can be obtained, in sequence, in successively smaller concentric squares, until k=1 is reached, where the Cartesian samples are already present among the pseudo polar samples. This approach can be likened to peeling an onion. (See FIG. 11.)

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method of encoding and sampling MRI K-space, comprising:
a. producing a static magnetic field in the Z-direction;
b. transmitting an RF pulse into a sampling region to as to excite the spins of a sample within the sampling regions so that the spins have x-y components;
c. producing a first time varying gradient field in the x direction, Gₓ;
d. producing a second time varying gradient field in the y direction, G_{y},
where
$${G}_{x} = \frac{2 m}{N} {G}_{y} , m ∈ [ - N / 2 , N / 2 ]$$
N is the number of pixels in the image in the x-direction, and
m is the indice of the rays;
e. receiving RF signals from the sample created by the spins of the sample, so as to produce K-space data where each data point in K-space corresponds to a unique combination of Gₓ and G_{y} values;
f. repeating c-e, where
$${G}_{y} = \frac{2 m}{N} {G}_{x} , m ∈ [ - N / 2 , N / 2 ] ; and$$

2. A method of magnetic resonance imaging, comprising:
a. producing a static magnetic field in the Z-direction;
b. transmitting an RF pulse into a sampling region to as to excite the spins of a sample within the sampling regions so that the spins have x-y components;
c. producing a first time varying gradient field in the x direction, Gₓ;
d. producing a second time varying gradient field in the y direction, G_{y},
where
$${G}_{x} = \frac{2 m}{N} {G}_{y} , m ∈ [ - N / 2 , N / 2 ]$$
N is the number of pixels in the image in the x-direction, and
m is the indice of the rays;
e. receiving RF signals from the sample created by the spins of the sample, so as to produce K-space data where each data point in K-space corresponds to a unique combination of Gₓ and G_{y} values;
f. repeating c-e, where
$${G}_{y} = \frac{2 m}{N} {G}_{x} , m ∈ [ - N / 2 , N / 2 ] ; and$$
g. reconstructing an image of the sample from the K-space data.

3. A method of magnetic resonance imaging, comprising:
acquiring K-space data points on a pseudo-polar grid, and creating an image from the acquired K-space data.

4. The method according to claim 3,
wherein the pseudo-polar grid is a point at the origin of K-space and N linearly growing concentric squares, where N≧2, wherein the distance between adjacent concentric squares is equal to the distance from the origin to the inner square, wherein N+1 K-space data points are acquired on each side of each square including the corners of each square, wherein the distance between each K-space point on the side of each square is equally spaced from adjacent K-space data points, wherein 2N rays can be drawn in K-space such that each ray passes through the origin of K-space and through two K-space data points on each square, wherein the two data points on each square lie on opposite sides of the square.

5. The method according to claim 4,
wherein acquiring K-space data points on a pseudo polar grid comprises acquiring K-space data on only two adjacent sides of the outer square, wherein acquiring K-space data on only two adjacent sides of the outer square comprises acquiring K-space data at two corners of the outer square, wherein the two corners are the corner of intersection between the two adjacent sides of the outer square and a corner at the end of one of the two adjacent sides.

6. The method according to claim 5,
wherein acquiring K-space data points comprises acquiring 4N²−2N+1 K-space data points.

7. The method according to claim 6,
wherein N≧128.

8. The method according to claim 6,
wherein N≧256.

9. The method according to claim 4,
wherein 4N²+1 K-space data points are acquired, wherein 4N²−2N+1 are used to create the image such that K-space data on only two adjacent sides of the outer square are used to create the image, wherein the K-space data on only two adjacent sides of the outer square is K-space data at two outer corners of the outer square, wherein the two corners are the corner of intersection between the two adjacent sides of the outer square and a corner at the end of one of the two adjacent sides and K-space data on the interior of the two adjacent sides.

10. The method according to claim 6,
wherein N is an even number.

11. The method according to claim 6,
wherein N is a power of 2.

12. The method according to claim 6,
wherein N is odd.

13. The method according to claim 3,
wherein creating an image from the acquired K-space data comprises creating an image from the acquired K-space data via the adjoint Fractional FFT.

14. The method according to claim 13, further comprising:
modifying the image via the conjugate gradient method to produce a modified image.

15. The method according to claim 14,
wherein modifying the image comprises solving (\tilde{P}P)I=Ĩ, where Ĩ is the image, \tilde{P} is the adjoint Fractional FFT, P is the Fractional FFT, and I is the modified image.

16. The method according to claim 3,
wherein the pseudo-polar grid is a point at the origin of K-space and N linearly growing concentric cubes, wherein N≧2, wherein the distance between adjacent concentric cubes is equal to the distance from the origin to the inner cube, wherein N+1 K-space data points are acquired on each edge of each cube including the corners of each cube, wherein the distance between each K-space point on each edge of each cube is equally spaced from adjacent K-space data points.

17. The method according to claim 16,
wherein acquiring K-space data points comprises acquiring 6N³−3N²+1 K-space data points.

18. The method according to claim 17,
wherein N≧128.

19. The method according to claim 17,
wherein N is even.

20. The method according to claim 17,
wherein N is odd.

21. The method according to claim 17,
wherein N is a power of 2.

22. The method according to claim 16,
wherein 6N³+1 K-space data points are acquired, wherein 6N³−3N²+1 are used to create the image such that K-space data on only a portion of the outer cube are used to create the image.

23. The method according to claim 13,
wherein only a portion of the image is used as a region of interest.

24. The method according to claim 13, further comprising:
modifying the image via the onion peel method to produce a modified image.

25. The method according to claim 15, wherein solving (\tilde{P}P)I=Ĩ comprises iteratively solving (\tilde{P}P)I=Ĩ.

26. The method according to claim 2,
wherein reconstructing an image of the sample from the K-space data comprises reconstructing the image of the sample from the K-space data via the adjoint Fractional FFT.

27. The method according to claim 26, further comprising:
modifying the image via the conjugate gradient method to produce a modified image.

28. The method according to claim 27,
wherein modifying the image comprises solving (\tilde{P}P)I=Ĩ, where Ĩ is the image, \tilde{P} is the adjoint Fractional FFT, P is the Fractional FFT, and I is the modified image.

29. The method according to claim 4,
wherein creating an image from the acquired K-space data comprises creating an image from the acquired K-space data via the adjoint Fractional FFT.
